(19) United States
(12) Patent Application Publication
(10) Pub. No.: US 2008/0243857 A1
(43) Pub. Date: Oct. 2, 2008

(54) Method for Editing a Multimedia Page Using Pre-Stored Data

(75) Inventor: Cedric Gegout, Rennes (FR)

Correspondence Address: MCKENNA LONG & ALDRIDGE LLP, 1900 K STREET, NW, WASHINGTON, DC, 20006, US

(73) Assignee: France Telecom

(21) Appl. No.: 10/589,198

(22) PCT Filed: Feb. 13, 2004
(86) PCT No.: PCT/FR04/00337

§ 371 Date: May 21, 2007

(51) Int. Cl. G06F 17/30

(52) U.S. Cl. 707/10; 707/E17.032

(57) ABSTRACT

This invention relates to multimedia page editing on a terminal. A server (SER) supplies pages to the terminal (TER) in the form of object arrangement commands for objects in a multimedia page to be generated. The method according to the invention comprises a preliminary step wherein the server transmits on object-related data packet as well as a temporary store (CACHE) for the data (DATA), which is identified by a link (node i) in a terminal memory; and a main step wherein the server transmits a descriptive file containing said link for editing the object in a scene being generated in the terminal on the basis of the stored data.

The invention relates to the editing of multimedia pages on terminals, in particular in the context of multimedia services provided on cellphones arranged to cooperate with cellular networks.

In the context of the invention, a server supplies one or more terminals with at least some multimedia pages in the form of object arrangement instructions for objects in a multimedia page to be generated.

In this context, one and the same object can be used in particular by several successive multimedia pages and retain, or not retain, the same arrangement parameters from one multimedia page to the next.

The term “multimedia page” is used, for example, to mean a graphic scene to be edited on the terminal, possibly augmented by one or more sound sequences to be played on terminal headphones or speakers.

For example, for graphically editing a plan of a town on a mobile terminal, one and the same object (for example, a graphic object such as a road map) is likely to be edited in a number of successive scenes if the user of the terminal applies an interactive command of the zoom-in/zoom-out type or “left arrow/right arrow, up/down” type to adjust a display position of the plan. In this case, on each interaction command from the user, the server usually transmits the same data relating to the graphic object to be edited, possibly with parameters for arranging the object in the graphic scene (for example, a zoom value) that are different.

This then raises the problem of systematic and unnecessary transmission and storage of data relating to one and the same object, for a number of multimedia pages in which the same object occurs, possibly with different arrangement parameters. This problem becomes particularly acute when there is a need for a number of interchanges between the terminal and the server, all the more so when the bandwidth allocated for the communication between the server and the terminal (particularly a mobile terminal) may be restricted.

The present invention proposes a mechanism for storing data specific to objects intended to be arranged in multimedia pages. More particularly, the invention proposes a method of transmitting and decoding “cache” functions (that is, a read-ahead followed by a store) concerning object data, prior to the space-time arrangement of these objects in a multimedia page.

Regarding the editing of graphic scenes, a number of graphic formats for representing graphic animations currently exist. However, none of these formats proposes a mechanism for “caching” information on the graphic objects that are described in the graphic representation.

Techniques that make it possible to manage “cache” information for a graphic scene using programmatic methods (for example in MPEG/MPEGJ or VRML/EAI mode) or even protocol-oriented methods (for example in http, RTP, or other modes), but for a quite different purpose from that of the present invention, are known. Moreover, these techniques suffer from a lack of flexibility in that it is impossible to download pieces of programmatic content, or even because such techniques necessarily use the abovementioned protocol-oriented mechanisms. They also suffer from a lack of efficiency in graphic rendition in that it is often necessary to run a virtual machine to process the programmatic content.

One aim of the present invention concerns reducing the memory of the terminals needed to edit complex multimedia pages, or a succession of such pages.

Another aim of the present invention concerns reducing the computation resources needed to edit such pages, or a succession of these pages.

Another aim of the present invention is to provide a method with which to accomplish the abovementioned aims while offering compatibility with the conventional decoding techniques.

More generally, an aim of the present invention is to offer greater flexibility in the requests and data interchanged between the server and the terminal.

The present invention first proposes a method of editing multimedia pages on a terminal, wherein a server supplies one or more terminals with at least a part of the multimedia pages in the form of object arrangement instructions for objects in a multimedia page to be generated,

the method comprising:
a) at least a preliminary step during which the server transmits data relating to at least one object to be arranged in a multimedia page to be generated, with an instruction to store said data, identified by a link, in a terminal memory,
b) and at least a main step during which the server transmits a descriptive file containing said link, to edit, on the terminal, said object in at least one multimedia page being generated, by reading the data stored in the terminal memory.

Thus, the method according to the invention offers greater flexibility in the requests and data interchanged between the server and the terminal, by allowing a look-ahead to the object or objects that will be edited in the multimedia pages by the terminal. Typically, the step b) on its own can be repeated several times to edit the same object in a number of successive multimedia pages, advantageously without necessarily downloading from the server the object-related data for each multimedia page to be generated.

In an embodiment, the server transmits said data and the store instruction to the terminal in at least one data packet.

The storage in the terminal memory is preferably temporary and the abovementioned store instruction includes, in this embodiment, a timer parameter of predetermined value defining an expiry date, counted from its receipt on the terminal.

In another embodiment, the abovementioned instruction is of “cache” type between the server and the terminal, with a memory area of the terminal allocated to store the data associated with this instruction, in order to speed up a subsequent, repeated execution of the step b) for the same object.

In an embodiment, the store instruction includes information relating to a number of data items that the terminal must store in memory. For example, the store instruction can include a data record start marker and a data record end marker, such that the abovementioned number of data items is defined by this pair of markers.

Advantageously, the abovementioned descriptive file contains a script including one or more links in the form of URL (UNIVERSAL RESOURCE LOCATOR) requests.

Advantageously, the store instruction is implemented in the form of a command corresponding to a low-level function.

It is also indicated that many graphic scenes using a representation in the form of a list of primitives (single functions, simple to execute and so-called “low level”). The “cache” description functions are then used to anticipate the transmission and reading of a number of graphic scenes within a composite multimedia service. This low-level representation of the “cache” functions allows for a detailed interaction with the objects of the animation while handling a binary transfer between the server and the terminal, in particular a mobile terminal. Thus, the latency time is reduced for the end user of the terminal.

In an embodiment, the object is a graphic-type object comprising at least one of the following elements:
an image,
a sequence of images,
a sequence of 2D synthetic images,
and a sequence of 3D synthetic images.

It should be indicated that such sequences of images are likely to be used, for example, by the MPEG-4 standard, for editing graphic scenes.

Since this store instruction appears to be an essential means for implementing the above method, another aim of the present invention is to produce a program product in the form of computer code, and including an instruction to store, in a memory of a terminal, data relating to an object that is to be edited, on said terminal, in one or more multimedia pages in which the object is likely to occur. Another aim of the present invention is to provide a signal containing this code. This signal and/or the program product itself, can be transmitted from the server to the terminal, or even originate from a memory medium that cooperates with a drive of the terminal (such as a CD-ROM or other drive).

Other characteristics and advantages of the invention will become apparent from studying the detailed description below, and the appended drawings in which:

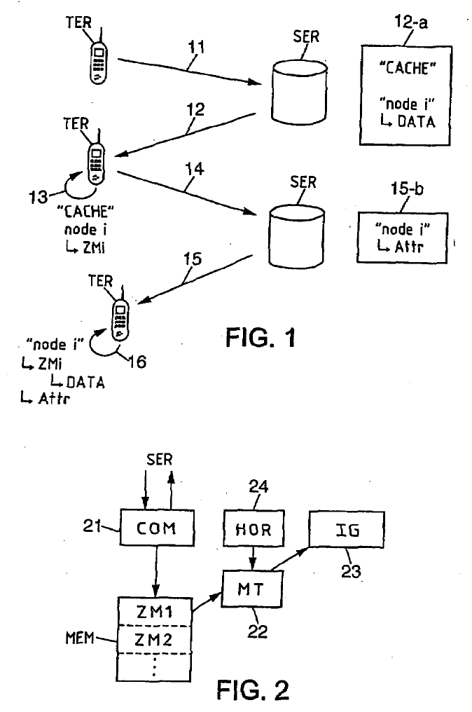

FIG. 1 illustrates the interchanges between a server SER and a terminal TER, for the steps of the method according to the invention,

FIG. 2 diagrammatically and partially represents the elements of a terminal TER, and

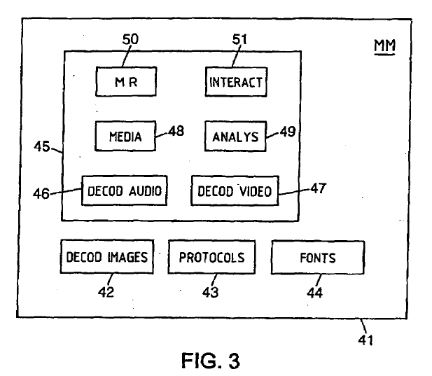

FIG. 3 represents software agents interacting to edit multimedia pages on the terminal TER.

The appendix contains a transcription of a computer code of the “CACHE” command (in binary format) corresponding to the abovementioned store instruction. It must be understood in particular that the description and its appendix describe characteristics that might contribute to the definition of the invention.

By referring to FIG. 1, the application context of the invention can be described by the following steps:
The mobile terminal TER requests one or more multimedia pages, for example a graphic animation content, from a server SER (step 11).
The server SER returns a content (step 12) containing data (audio, video, text, or other) specific to an object, for example a graphic object to be edited in a graphic scene. In this content, there is described a temporary store function “CACHE” (corresponding to the abovementioned store instruction), as is shown in table 12-a. This “CACHE” function indicates that a set of graphic objects will be stored in memory in the terminal and will, where appropriate, be accessible in response to a request from the same terminal. This function therefore indicates to the terminal TER that it must store data relating to an object likely to occur in one or more future graphic scenes to be generated. This object is identified by a graphic node “node i” with which are therefore associated the data DATA specific to the graphic object.
The terminal stores this data DATA (step 13) in a memory area ZMi of the terminal, identifiable by a link, for example a character string “node i”.
The server SER sends (step 15) the description of a scene incorporating the object “node i”, possibly with attributes Attr for arranging the object in the scene (descriptive file, in the form of script 15-b, for example).
The terminal TER recognizes the link “node i” to the memory area ZMi and recovers (step 16) the data DATA previously stored in the step 13 to edit a graphic scene including the object corresponding to the node “node i”, with the arrangement attributes Attr that the server transmitted in the step 15.
Where appropriate, the terminal can ask the server for new attributes, for the same object “node i”, to edit a new graphic scene including this same object (step 14), if the storage life of the data DATA on the terminal allows it, as will be seen later.

This CACHE command is used to temporarily store a set of data DATA specific to an object of a scene to be generated. This command is preferably grouped with the data DATA in one and the same packet (for example, an AccessUnit packet in an MPEG-4/System, or even an RTP packet). To modify a current scene, the server transmits subsequent packets (containing one or more commands).

Reference is now made to FIG. 2 to briefly describe modules conventionally provided in a terminal TER. The terminal comprises a communication module 21, for communication in particular with the server SER, from which it receives the abovementioned “CACHE” command. This CACHE command has a graphic node “node i” associated with it and the terminal stores the data DATA in a memory area ZMi (i=1, 2, etc.) mapped to this node “node i”. This memory area ZMi is provided in a memory MEM contained in the terminal TER.

Then, a subsequent command transmitted by the server and relating to the object identified by the node “node i”, will be interpreted by the terminal as targeting the content of the memory area ZMi and will therefore be used to recover the data DATA relating to this object. This data DATA is then processed in a working memory 22 (for example, by software on the terminal called “PLAYER”), possibly separate from the memory MEM. The information used to edit the scene to be generated is then transferred to an interface 23, for example, a graphical interface for displaying the scene (or even via a sound interface for a sound rendition). Since this data DATA is preferably temporary, reference will be made to the real-time clock value read from a clock 24, normally provided in a terminal (in its processor, in particular).

There follows a description of the semantics of the command “CACHE” (described in binary format in the appendix and called cacheObject).

A “cacheObject” packet is used to send in advance a content that will be executed, for example, in response to a URL request (for example, following the steps 14 and 15 in FIG. 1). This request can be made following a command from a user of the terminal (interactive command). A cacheObject may be permanent, in its definition, and stored in memory at any time.

However, the data associated with the cacheObject has an expiry date (in the terminal memory) defined by the reception time and the time to live TTL of its data stored temporarily. This TTL attribute gives the time in seconds after which the cacheObject is no longer valid.

The attributes that are associated with this cacheObject command are, for example, as follows:
TTL: validity time of the cacheObject
URL: the cacheObject data is recovered from the memory MEM, in response to this URL link
Source: the data DATA to be stored which can then be recovered.

With regard to the attributes Attr that are then sent with the node “node i”, examples include a color and a font associated with a text to be displayed on the terminal, whereas the character string itself of the text to be displayed has been stored previously in memory MEM of the terminal, as data DATA sent with the CACHE command according to the invention.

It should be stated that most graphic scenes normally require a representation in the form of a list of graphic rendition primitives (low-level functions). Each of these primitives has a single, simple function, to assign a graphic editing parameter. The CACHE store function, according to the invention, is advantageously a low-level function. A low-level representation of this function makes it possible in particular to have a detailed interaction with the objects of the animation and a binary transport between the server and the terminal, in particular a mobile terminal.

More specifically, the appendix contains a transcription of the “cacheObject” instruction, in Synthetic Description Language (SDL), corresponding to a code adopted to define the bitstream formats, with bytes associated with each field. Details concerning this computer language can be found in the description of the ISO standard IEC 144-96.

It is indicated here that the CACHE command is declared by the instruction const bit(4) 12 which means that this command is declared by the integer “12” which must be located in the first four bits of the bitstream received by the terminal. Thus, if these first four bits include the integer “12”, they will declare the command CACHE. Then, the command bit(6) msgID declares the integer msgID which, depending on its value, when it is received by the terminal, can initiate various actions on the terminal. Here, these actions are “Permanent” (indicates whether the terminal must keep the data of the object in memory or not) and “Replace” (indicates whether the terminal must replace the content of its stored data with the new incoming data). Combinations of these actions (or non-actions) are also provided, depending on the value of msgID.

The following commands uint(X) declare:
the number of bytes to be read and to be stored “payloadLength”,
the lifetime of the data stored in memory “TTL”, and
a time to read “time”, from a clock of the terminal 24 (FIG. 2), to comply with the time to live TTL.

The command byte(8) [payloadLength] payload indicates that the terminal must read and, where appropriate (depending on the value of the variable msgID), save all the data that it receives from the server until it reads the marker “payloadLength”.

Finally, the following command STZString defines a way of reading a character string to read a URL link either to the memory of the terminal, or to server html pages.

Thus, the server transmits multimedia pages which contain links and the responses associated with these links with an instruction to store these responses on the terminal. The terminal can either accept, or reject, storing these responses, for example if they are too big or if the expiry time is too short or too long. Following an interaction of the user or the execution of a script for a request for the content of a link in one of the multimedia pages, the terminal has priority access to the response stored on the terminal, if it is actually stored.

Reference is now made to FIG. 3 to describe a graphic scene transmission and rendition model.

A plurality of modules 42 (various image decoders), 43 (network protocol management), 44 (text font (or character) management), are stored in memory 41 of the terminal TER, as memory-resident. Furthermore, a client software 45, called “PLAYER”, is also stored as memory-resident in the memory 41.

The PLAYER 45 is used to display animated, interactive and multimedia contents on the mobile terminal. Mainly, this software downloads or reads information that describes the space-time arrangement of graphic objects, the way in which they are synchronized and the interactions of the user of the terminal that are possible on this content.

The PLAYER 45 then interprets the interactions of the user and deduces from them the appropriate behaviors of the graphic objects or the requests to be made to the content server. The PLAYER 45 (for example, of “STREAMEZZO” type) includes graphic object rendition functions and engines for display (graphic rendition engine 50) and interaction (interaction engine 51) with the multimedia scene. The PLAYER 45 uses the modules 42, 43, 44 as API (Application Program Interface) for the system of the mobile terminal that are used:
to decode the images (module 42),
to recover a stream coming from the network or from a local source (module 43), and
to manage the display of the text and in particular the fonts resident as standard in the mobile terminal (module 44).

The contents for editing comprise animated vector graphics, sound, video and user interactions. Displaying interactive multimedia contents, in mobile environments, normally entails using compression techniques in order to ensure an effective provision of the content and an optimization of the rendition of the graphic objects that make up this content. This content can then be displayed in good conditions on the mobile terminals. The information read or downloaded by the PLAYER 45 is then highly compressed and the PLAYER must therefore decompress this data and interpret it on the fly to play the content.

More specifically, the PLAYER 45 includes audio and video decoding modules, respectively 46 and 47, a decoded stream analyzer 49, a media manager 48, a rendition engine (graphic or sound) 50 and an interactivity engine 51.

The operation of the PLAYER software can be described by the following steps:
entry of the input data via a network connection or a file read,
decompression of this data in order to obtain a description of the graphic objects that can be directly used by the audio and graphic rendition engine 50,
composition of the graphic objects together to create a graphic scene,
graphic rendition proper of the audio and graphic objects, by display of visual objects or by playing a sound,
recognition of the user interactions, for example a
click on a pointer, or a key press, or other,
setting up of a connection to a local or remote information source if necessary.

Following a request from the user, the latter step will consist in opening a connection to the server SER and recovering a bitstream. This bitstream is analyzed by the PLAYER 45 which then creates an object SceneGraph containing the various objects of the scene in the form of nodes of a graph. The information stream is divided into packets which contain information which, in a preferred embodiment, is valid only at a given time and corresponds to a single type of information “AccessUnit” principle of the MPEG-4 standard).

The PLAYER analyzes each packet and executes the commands that are described in it according to its clock (not shown in the figures), which supplies the time of the multimedia scene and, where appropriate, the time to live TTL of the data DATA associated with a CACHE command.

Thus, it will be understood that this PLAYER 45, particularly with the other modules 42, 43 and 44 of the terminal, can handle the process for receiving and decoding a store function CACHE for graphic object data occurring in graphic scenes, according to the present invention.

This store function is used to manage the representation of an object and/or the modification of its arrangement in a scene, without having to systematically download the same data of the object in the terminal. Thus, this function makes it possible to link several graphic scenes into a composite multimedia service, advantageously when the same object occurs frequently in these scenes.

More generally, the method according to the invention allows the terminal memory (for example the graphic memory) to be reduced, since only the data store instruction is stored on the graphic nodes.

The method according to the invention also allows for a saving in the use of computation resources, since, typically, the use of a programmatic content as defined above would incur a net computation overhead, at least for some animations. Advantageously, the method according to the invention, using a mechanism in accordance with a conventional graphic command rendition process, in a preferred embodiment, is then easy to implement, particularly for a system with mobile terminals cooperating with cellular networks.

The method according to the invention also offers a compatibility with the conventional decoding techniques, since the method can be implemented in most graphic rendition devices.

It should be indicated that the method according to the invention, which is very general, can be applied to practically all the current graphic animation descriptions such as MPEG-4/BIFS, SVG, and others, provided that an application requires the representation of its constituent signals in the form of a space-time arrangement of graphic objects.

APPENDIX
cacheObject {

constbit(4) 12;
bit(6) msgID;
if (msgID == 2) {

isPermanent = false;
isReplace = true;

} else if (msgID == 4) {

isPermanent = true;
isReplace = true;

} else if (msgID == 6) {

isPermanent = false;
isReplace = false;

} else if (msgID == 7) {

isPermanent = true;
isReplace = false;

}
uint (24) payloadLength;
uint(32) time;
byte(8) [payloadLength] payload;
uint(32) TTL;
STZString url;

}
STZString {

uint(5) len;
uint(len) slen;
byte(8) [len] UTF-string;

}

1. A method of editing multimedia pages on a terminal, wherein a server supplies one or more terminals with at least a part of said multimedia pages in the form of object arrangement instructions for objects in a multimedia page to be generated,
characterized in that the method comprises:
a) at least a preliminary step during which the server transmits data relating to at least one object to be arranged in a multimedia page to be generated, with an instruction to store said data, identified by a link, in a terminal memory,
b) and at least a main step during which the server transmits a descriptive file containing said link, to edit, on the terminal, said object in at least one multimedia page being generated, by reading the data stored in the terminal memory.

2. The method as claimed in claim 1, characterized in that the server transmits said data and the store instruction to the terminal in at least one data packet.

3. The method as claimed in one of claims 1 and 2, characterized in that the storage in the terminal memory is temporary.

4. The method as claimed in claim 3, characterized in that said instruction includes a timer parameter of predetermined value defining an expiry date, counted from its receipt on the terminal.

5. The method as claimed in one of the preceding claims, characterized in that said instruction is of “cache” type between the server and the terminal, with a memory area of the terminal allocated to store the data associated with said instruction, in order to speed up a subsequent, repeated execution of the step b) for the same object.

6. The method as claimed in one of the preceding claims, characterized in that the store instruction includes information relating to a number of data items that the terminal must store in memory.

7. The method as claimed in one of the preceding claims, characterized in that said descriptive file contains a script including one or more links in the form of URL requests.

8. The method as claimed in one of the preceding claims, characterized in that said store instruction is implemented in the form of a command corresponding to a low-level function.

9. The method as claimed in one of the preceding claims, characterized in that the terminal is a mobile terminal arranged to cooperate with a cellular network.

10. The method as claimed in one of the preceding claims, characterized in that said object is a graphic-type object comprising at least one of the following elements:
an image,
a sequence of images,
a sequence of 2D synthetic images,
and a sequence of 3D synthetic images.

11. A program product in the form of computer code, characterized in that it includes an instruction to store, in a memory of a terminal, data relating to an object that is to be edited, on said terminal, in one or more multimedia pages in which said object is likely to occur.

12. A signal comprising a computer code, characterized in that the code contains an instruction to store, in a memory of a terminal, data relating to an object that is to be edited, on said terminal, in one or more multimedia pages in which said object is likely to occur.
